(19) United States
(12) Patent Application Publication
(10) Pub. No.: US 2026/0045092 A1
(43) Pub. Date: Feb. 12, 2026

(54) SYSTEM AND METHOD FOR CONTEXT-AWARE ANIMAL ACCESS CONTROL

(71) Applicants: Joel Kenneth Pearman, Palomar Mountain, CA (US); Sonrisa Smiley, Palomar Mountain, CA (US)

(72) Inventors: Joel Kenneth Pearman, Palomar Mountain, CA (US); Sonrisa Smiley, Palomar Mountain, CA (US)

(21) Appl. No.: 19/294,257

(22) Filed: Aug. 7, 2025

Related U.S. Application Data
(60) Provisional application No. 63/681,075, filed on Aug. 8, 2024.

(51) Int. Cl. G06V 20/52; G06V 10/70; G06V 10/764; G06V 10/774; G06V 10/98; G06V 40/10; H04N 7/18

(52) U.S. Cl. CPC G06V 20/52; G06V 10/764; G06V 10/768; G06V 10/7747; G06V 10/987; G06V 40/10; H04N 7/183

(57) ABSTRACT

An animal access control system includes a door assembly with an electronic lock, a local camera at the door, and at least one external camera monitoring a surrounding environment. A processor analyzes image data from the cameras using a computer vision model. By synthesizing data from both local and external sources, the system generates a comprehensive situational context. Based on this context, the system proactively controls access. It may lock the door to prevent a pet from exiting into a detected threat, or it may play an audible recall signal and unlock the door to provide a safe haven for a pet to escape a threat. The computer vision model can be trained by a user to recognize specific pets and is updated over time through user feedback and automated retraining.

### CROSS-REFERENCE TO RELATED APPLICATIONS

This application claims the benefit of U.S. Provisional Application No. 63/681,075, filed on Aug. 8, 2024, the contents of which are incorporated herein by reference in their entirety.

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A READ-ONLY OPTICAL DISC, AS A TEXT FILE OR AN XML FILE VIA THE PATENT ELECTRONIC SYSTEM

Not Applicable

### STATEMENT REGARDING PRIOR DISCLOSURES BY THE INVENTOR OR A JOINT INVENTOR

Not Applicable

### BACKGROUND OF THE INVENTION

### (1) Field of the Invention

The present invention relates generally to automated access control systems. More specifically, the invention pertains to an animal access system utilizing a distributed camera network and a trainable computer vision model to provide context-aware, proactive access control based on comprehensive situational awareness.

### (2) Description of the Related Art

Traditional pet doors range from simple, unsecured flaps to automated systems that rely on triggers like RFID tags embedded in a pet's collar. While providing some selective entry, these systems require the pet to wear a device and lack any environmental intelligence.

More recent advancements in the field have incorporated artificial intelligence (AI) and computer vision to create “smart” pet doors. An example of such a system is the unreleased Petvation pet door. These systems typically include one or more cameras mounted directly on the pet door frame to perform facial or full-body recognition. They can identify a user's registered pets and distinguish them from common nuisance animals, thereby granting or denying access.

However, these current smart door systems suffer from several significant deficiencies. The most critical limitation is that their functionality is inherently restricted by the narrow field of view of their integrated cameras. They can only perceive the area immediately at the threshold, making the system purely reactive. It can only make a decision when an animal is already at the door and lacks the data to understand the broader context of a situation. For instance, it cannot differentiate between a pet calmly wanting to enter and a pet being chased towards the door by a predator just out of the camera's sight.

Furthermore, the decision-making logic of these systems is typically simplistic. The rules are often binary (e.g., authorized pet vs. pest) and fail to account for the relative nature of threats or complex environmental factors. They lack the contextual data to determine, for example, that a door should remain locked to protect a housecat that is inside from a bobcat outside, but should be opened to allow a cat outside to escape that same bobcat. A large dog, on the other hand, may be allowed to exit the structure despite the bobcat's presence.

Additionally, the recognition models in existing systems are often static. While they may allow a user to register a pet, they generally lack robust mechanisms for long-term adaptation to a pet's changing appearance or for user-driven correction of the model's classification errors. Finally, these systems lack user-configurable monitoring zones, often leading to inefficient processing or false triggers caused by activity in irrelevant areas, such as on a public sidewalk or a neighbor's property.

Therefore, there is a clear need for a more advanced pet access system that overcomes these limitations. A need exists for a system that not only perceives the broader environment beyond the entryway but also employs a more sophisticated, context-sensitive rules engine and an adaptive, trainable recognition model to provide truly proactive and intelligent protection for pets and property.

### BRIEF SUMMARY OF THE INVENTION

The present invention is a system and method for intelligent animal access control that provides enhanced, proactive safety for animals and property by using a distributed camera network to generate comprehensive situational awareness of potential threats.

A goal of the invention is to overcome the limitations of prior smart pet doors, which are purely reactive to events occurring immediately at the door's threshold. The present invention achieves this by utilizing a door assembly with an electronic lock, and one or more external camera units that form a wireless mesh network to provide robust, long-range environmental monitoring. A processor analyzes image data from both the local and external cameras to generate real-time situational context.

This synthesized situational context allows the system to apply a set of advanced operational rules. For example, the system can proactively protect a pet by maintaining the door in a locked state to prevent it from exiting into a danger detected in the external environment. Conversely, the system can provide a safe haven by unlocking the door to allow a pet to enter and escape a threat detected in that same environment, even playing an audio tone to recall the pet. The system is further configured to deny unauthorized access.

The system includes a computer vision model that can be trained by the user to recognize individual pets and can be refined over time through both automated retraining and user-provided corrective feedback. Users may also customize the system's behavior via a companion application, including setting access schedules, defining which animals constitute a threat relative to their specific pets, and masking specific areas within the cameras'fields of view to prevent irrelevant detections.

### BRIEF DESCRIPTION OF THE SEVERAL VIEWS OF THE DRAWINGS

The accompanying drawings, which are incorporated in and constitute a part of this specification, illustrate embodiments of the invention and, together with the description, serve to explain the principles of the invention.

FIG. 1 is a perspective view of the animal access control system in its intended operational environment, illustrating the spatial relationship between the door assembly, the local camera, and the external camera.

FIGS. 2A and 2B are detailed views of the door assembly, showing orthographic views of both its exterior (2A) and interior (2B) sides, illustrating the primary physical components.

FIG. 3 is a schematic block diagram illustrating the electronic architecture of the system and the communicative coupling between its components.

FIG. 4 is a flowchart illustrating the primary method of operation for the access control system's logic.

FIG. 5 is a diagrammatic view illustrating a proactive threat defense scenario where the system prevents a pet from exiting into a detected danger.

FIGS. 6A and 6B are diagrammatic views illustrating a safe haven rescue scenario. FIG. 6A shows a “before” view where the system detects a pet in danger and opens the door while issuing a recall signal. FIG. 6B shows an “after” view where the pet is safely inside and the door has been secured.

FIG. 7 is a flowchart illustrating the process for training and retraining the system's computer vision model.

FIG. 8 is a front view of an exemplary interior control panel located on the door assembly.

FIGS. 9A-9F are diagrams illustrating exemplary user interface screens of the companion application used to configure and control the system. FIG. 9A shows a registration screen. FIG. 9B shows a scheduling screen. FIG. 9C shows a rules engine screen. FIG. 9D shows an activity log screen. FIG. 9E shows a user feedback interface for verifying and correcting system-generated classifications. FIG. 9F shows a camera configuration interface for defining masked areas.

FIG. 10 is a schematic block diagram illustrating the electronic architecture of an external camera unit.

FIG. 11 is a diagrammatic view illustrating the formation of a wireless mesh network between the door assembly and multiple external camera units to extend network range.

FIGS. 12A and 12B are orthographic views showing a front view (12A) and a side view (12B) of an exemplary external camera unit, detailing its physical components.

### DETAILED DESCRIPTION OF THE INVENTION

The following is a detailed description of embodiments of the invention. The description is not to be taken in a limiting sense; the purpose is illustrating the general principles of the invention. The scope of the invention is best defined by the appended claims.

The drawings illustrate a system and method for intelligent, context-aware animal access control.

### System Overview and Environment

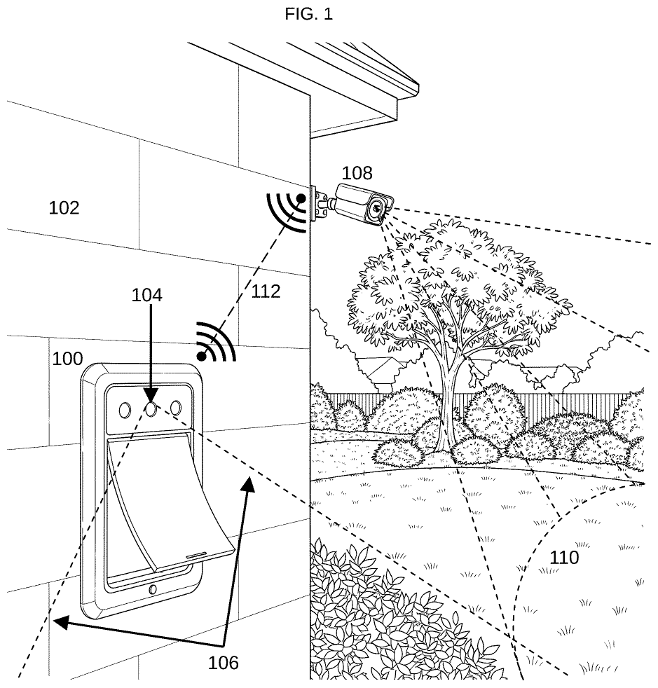

FIG. 1 illustrates an environmental view of the access control system in its intended operational context. The system comprises a door assembly (100) installed in a structure, such as a wall or door (102) of a house. The core innovation of the system lies in its use of a distributed camera network (112) to gather comprehensive situational data. This network includes at least one local camera (104), which is positioned on or within the door assembly (100). The local camera (104) is oriented to capture image data from a local area (106) immediately proximate to the door assembly (100), monitoring subjects that are intending to pass through.

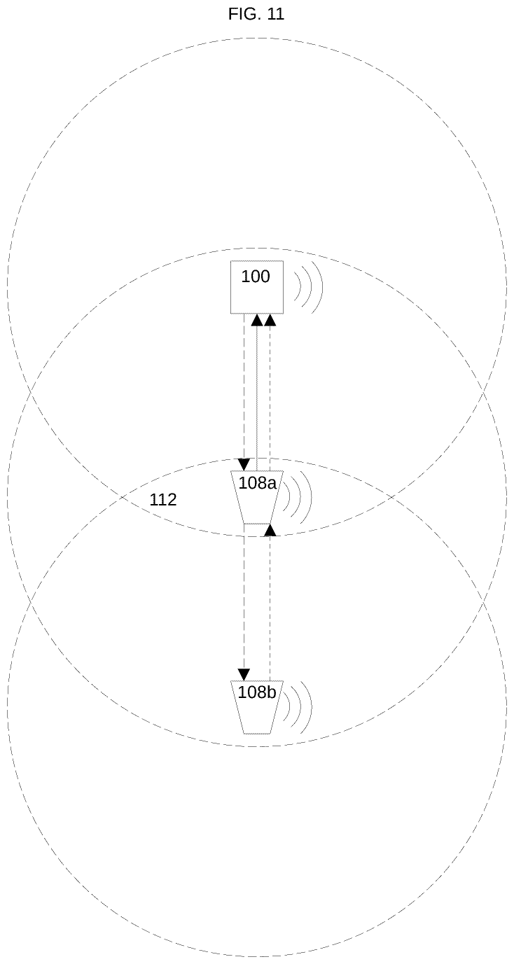

The system also includes at least one external camera (108), which is positioned remotely from the door assembly (100), for example, under the eaves of the structure (102). The external camera (108) is oriented to capture image data from a broad external environment (110), which may encompass the local area (106) but extends significantly beyond it. This dual-camera architecture allows the system not only to identify a subject at the door but also to understand the wider context in which the subject is operating, enabling proactive safety decisions. As illustrated in FIG. 11, the cameras may be connected via a secure wireless mesh network (112) to extend the operational range of the system and ensure robust data transmission.

### System Components and Architecture

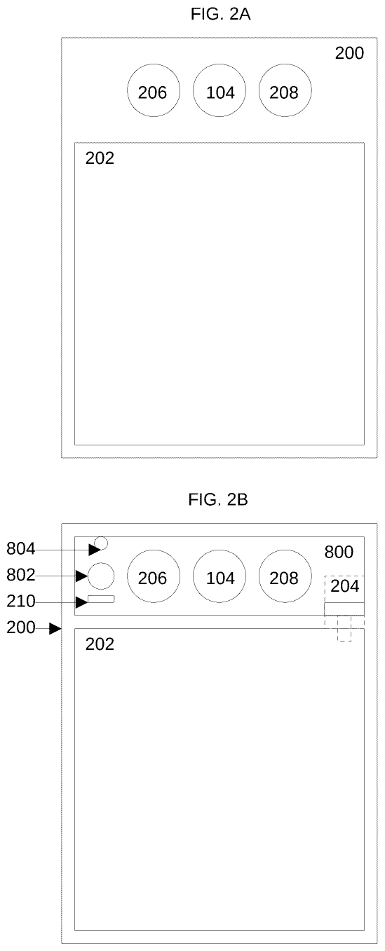

FIG. 2 provides a detailed view of the door assembly (100). FIG. 2A shows a perspective view of the exterior side of the assembly, illustrating the frame (200), the movable panel (202), the integrated local camera (104), an infrared (IR) light emitter (208), and an audio speaker (206). FIG. 2B shows a perspective view of the interior side of the assembly, illustrating the frame (200), the movable panel (202), the electronically-controlled locking mechanism (204) (e.g., a motor-driven bolt, pin, or solenoid with manual override switch) operatively coupled to the movable panel (202), the integrated local camera (104), an audio speaker (206) for providing audible cues, an infrared (IR) light emitter (208) to ensure consistent illumination for the local camera (104) in low-light conditions, one or more multifunction buttons (802), and one or more status indicator lights (804). The external camera (108) may similarly be equipped with an IR emitter and speaker. Both the interior and exterior panels may include other hardware such as a microphone, thermometer, and proximity sensors.

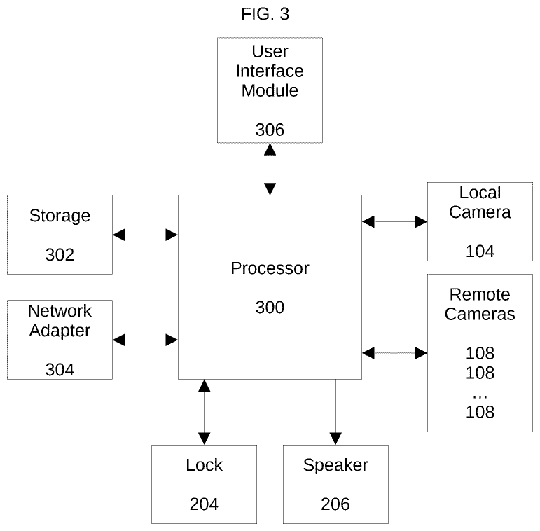

FIG. 3 illustrates a block diagram of the system's electronic architecture. At the heart of the system is a processor (300) communicatively coupled to all other components. A non-transitory computer-readable medium (302) (e.g., flash memory, a solid-state drive) stores instructions and data, including the computer vision model and predefined operational rules. The processor (300) receives image data from the camera network, which consists of the local camera (104) and one or more remote external cameras (108). The processor analyzes this data and, based on the stored rules, sends control signals to actuate the locking mechanism (204) and the audio speaker (206). A network adapter (304) (e.g., Wi-Fi, Bluetooth) facilitates communication with a remote user device and the external cameras. A user interface module (306) represents the physical controls on the door assembly itself.

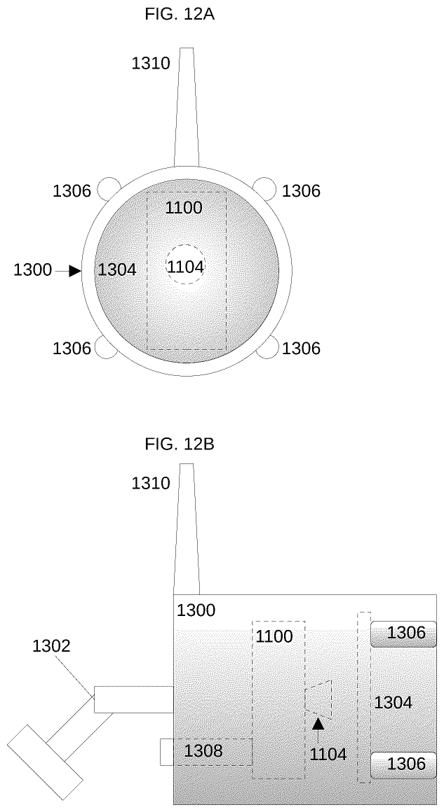

FIGS. 12A and 12B provide orthographic views of an exemplary external camera unit (108), showing a front view (12A) and a side view (12B). The unit is contained within a durable, weather-resistant housing (1300). The housing is attached to a mount (1302) for installation. The front view in FIG. 12A shows a protective lens (1304) covering a camera module, and a plurality of infrared (IR) emitters (1306) positioned around the lens. The positions of the internal microprocessor (1100) and camera module (1104) are also shown. The side view in FIG. 12B shows the housing (1300) and indicates the location of an internal microprocessor and a USB port (1308) for initial firmware flashing and service. An optional external Wi-Fi antenna (1310) may be included to enhance network connectivity. The cameras may also include other hardware, such as a speaker, a microphone, environmental sensors, and visible lights. The cameras could be attached to actuated mounts so they can pan and tilt to cover a wider area, or focus on an area with a threat. The camera module could be equipped with a zoom function as well.

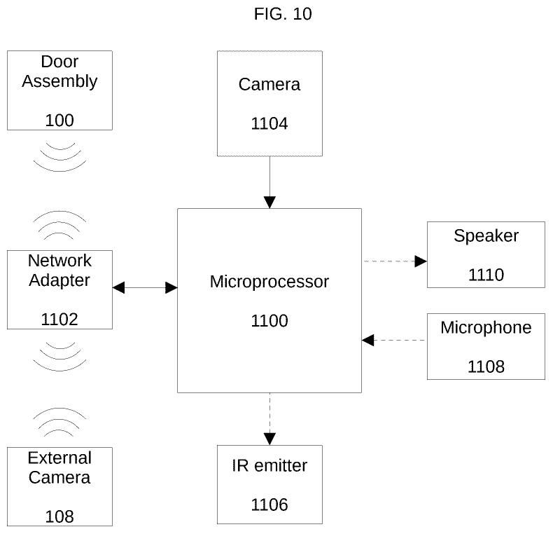

FIG. 10, a block diagram, illustrates the electronic architecture housed within the external camera unit (108). Each external camera unit may operate as an intelligent node within the network. It includes its own microprocessor (1100) and a network adapter (1102) for processing data and communicating with the main door assembly (100) and other camera units. The unit contains a camera sensor module (1104) to capture image data. Optionally, it may also include one or more infrared (IR) emitters (1106) for night vision, a microphone (1108) to capture audio data, and a speaker (1110) to emit sounds, such as deterrent noises or recall signals. As discussed above, the cameras could include a variety of other hardware.

FIG. 11 illustrates the configuration of the wireless mesh network (112). The door assembly (100) acts as the primary hub or base station for the network. A first external camera, Camera A (108a), is positioned within the direct wireless range of the door assembly (100). A second external camera, Camera B (108b), is positioned at a greater distance, outside the direct range of the door assembly (100) but within the range of Camera A (108a). The mesh network protocol allows Camera B (108b) to relay its data to the door assembly (100) by transmitting it through Camera A (108a), which acts as a repeater node. This configuration allows the system's surveillance and data-gathering capabilities to extend far beyond the range of a single wireless access point, enabling coverage of large properties. The mesh network is robust to both the addition and subtraction of individual nodes.

### System Setup and Configuration

The system is designed for flexibility, supporting both a simplified offline mode and a fully-featured networked mode.

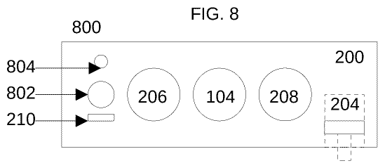

FIG. 8 illustrates an exemplary interior control panel (800) on the door assembly (100). This panel, visible on the interior side (FIG. 2B) of the door assembly, includes one or more multi-function buttons (802) and one or more status indicator lights (804). The control panel (800) also includes an infrared (IR) emitter (208), an audio speaker (206), a USB port (210), and the accessible portion of the locking mechanism (204). It may also include other elements such as a manual scheduling timer, microphone, and proximity sensors. The locking mechanism includes a manual override in case of power failure or extended disuse.

For initial offline operation after installation and power-on, a user can register authorized individuals without a network connection. The user first presses the button (802) to enter registration mode, indicated by the indicator light (804). The user then presents their own face to the local camera (104) to register themselves as an administrator.

Subsequently, the user can press the button (802) again to register each pet in sequence by presenting them to the local camera (104). In this default mode, the system will operate on a conservative schedule (e.g., allowing registered pet access from sunrise to sunset) and apply default safety rules. A manual timer interface may be included to facilitate offline scheduling.

To securely connect the system to a home Wi-Fi network, the user presses the button (802) on the interior control panel (800) to initiate a Bluetooth broadcast. Using the companion application (900), the user establishes a secure Bluetooth connection and provides the home's Wi-Fi credentials to the door assembly (100).

To add external cameras (108) to the system, the user uses a USB cable to connect the physical USB port (210) on the door assembly (100) to an external camera's USB port (1308) shown in FIG. 12B. The processor (300) detects the connection and automatically flashes a secure firmware onto the external camera (108). This process establishes a secure, pre-configured wireless connection between the door assembly and the camera, ensuring the network credentials are never exposed. The indicator light (804) signals when the flashing process is complete. This is repeated for each external camera. The user can then install the cameras in their desired locations, where they can be powered by a wall adapter or a solar and battery module. Upon powering on, they automatically connect to the secure wireless network and begin operation.

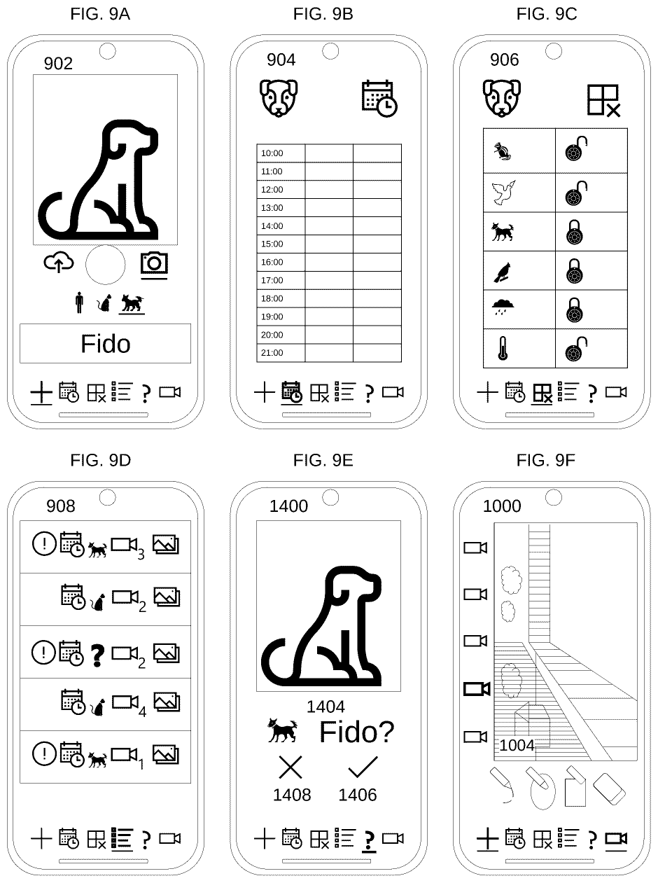

FIGS. 9A-9F illustrate exemplary user interface screens of a companion application (900) on a remote device, such as a smartphone, for the networked mode.

Once networked, the companion application (900) provides granular control over the system's behavior and user feedback for the vision model. As shown in FIG. 9A, a user can register individuals via a registration screen (902) where the user can photograph pets and input their species and size. FIG. 9B shows a scheduling screen (904) for setting custom access schedules. FIG. 9C shows a rules engine screen (906) for customizing system behavior, such as defining threats relative to specific pets, and whether the pet is allowed out in hot, cold, or inclement weather. FIG. 9D shows an activity log screen (908) for viewing recent events. FIG. 9E shows a user feedback screen (1400) where a user can view a system classification (1404) and either confirm (1406) or correct (1408) it to refine the model's accuracy. FIG. 9F shows a camera configuration screen (1000) for defining masked areas (1004) to be ignored by the processor.

### Method of Operation and Logic

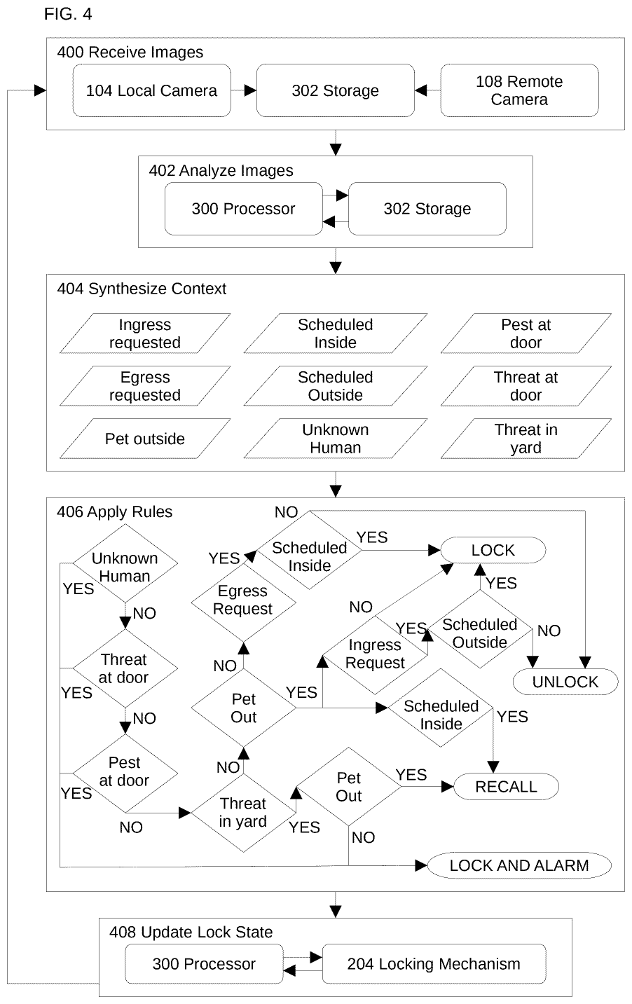

FIG. 4 is a flowchart illustrating the primary operational logic of the invention. The process begins with the system continuously monitoring its environment by receiving image data (Step 400) from both the local camera (104) and the external camera(s) (108). The processor (300) then analyzes the image data (Step 402), specifically focusing on the unmasked regions of the field of view as defined by the user (see FIG. 9F), using its computer vision model to generate classifications for any subjects depicted. These classifications can identify the species and, if trained, the specific individual identity of a subject.

Next, the system synthesizes the classifications to determine situational context (Step 404). This is a critical step where data from the local and external cameras are combined. For example, the context could be: “Authorized pet ‘Fido’ is at the door requesting ingress (from local camera), and the yard is clear (from external camera).” Or, it could be: “Authorized pet ‘Whiskers’ is at the door requesting egress (from local camera), but a coyote has been identified in the yard (from external camera).”

The system then applies a set of predefined rules (Step 406) to this situational context. Based on the outcome of the rule application, the system selectively actuates the locking mechanism (Step 408) to either grant or deny access. These default rules could be modified by the user with the companion application (900).

### Operational Scenarios

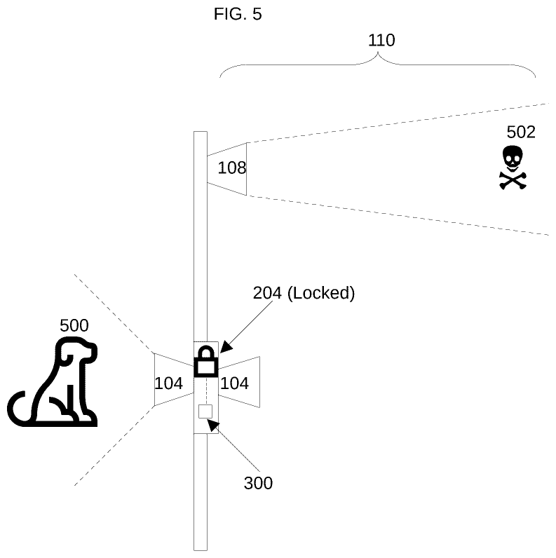

FIG. 5 illustrates a proactive threat defense scenario. A recognized pet, Pet A (500), is inside the structure and is detected by the local camera (104) requesting egress. Simultaneously, the external camera (108) detects a predefined threat (502), such as a coyote, in the external environment (110). Based on the rule “do not allow a pet to exit into danger,” the processor (300) maintains the locking mechanism (204) in a locked state, preventing Pet A (500) from entering a dangerous situation.

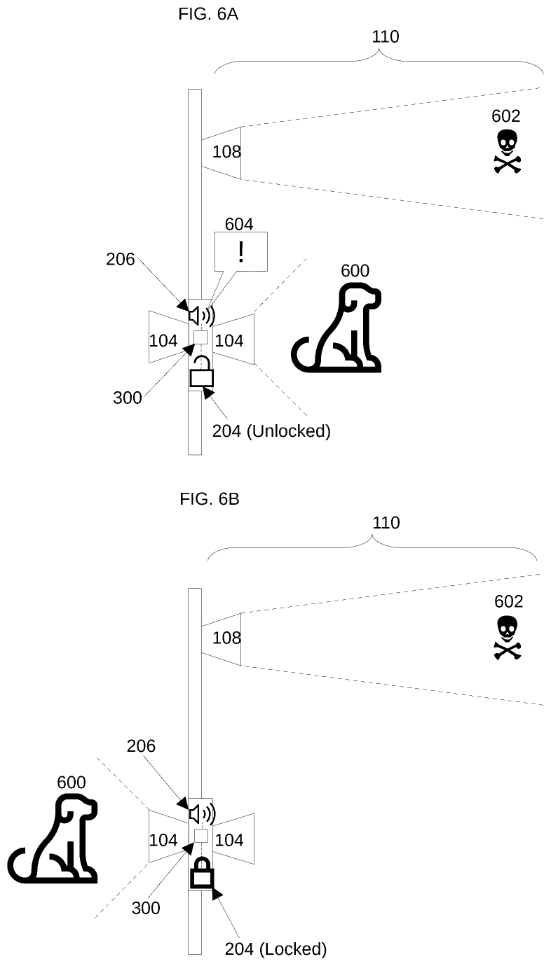

FIGS. 6A and 6B illustrate a safe haven rescue scenario. In FIG. 6A, a recognized pet, Pet B (600), and a predefined threat (602) are both detected in the external environment (110) by the external camera (108). The rule set identifies that Pet B (600) is in danger. In response, the processor (300) actuates the audio speaker (206) to generate a recall signal (604) to prompt the pet to return. Concurrently, the processor actuates the locking mechanism (204) to an unlocked state, ensuring Pet B (600) can immediately escape into the structure. As shown in FIG. 6B, once the system confirms the pet is safely inside, the processor (300) returns the locking mechanism (204) to its locked state to secure the structure from the threat (602).

Additional rules govern other scenarios. If an unknown human is detected by either camera, the door remains locked as a primary security measure. If a non-threatening pest is detected at the door, the door will remain locked to prevent the pest from following a pet inside. These rules are user configurable through the companion application (900).

### Computer Vision Model Training

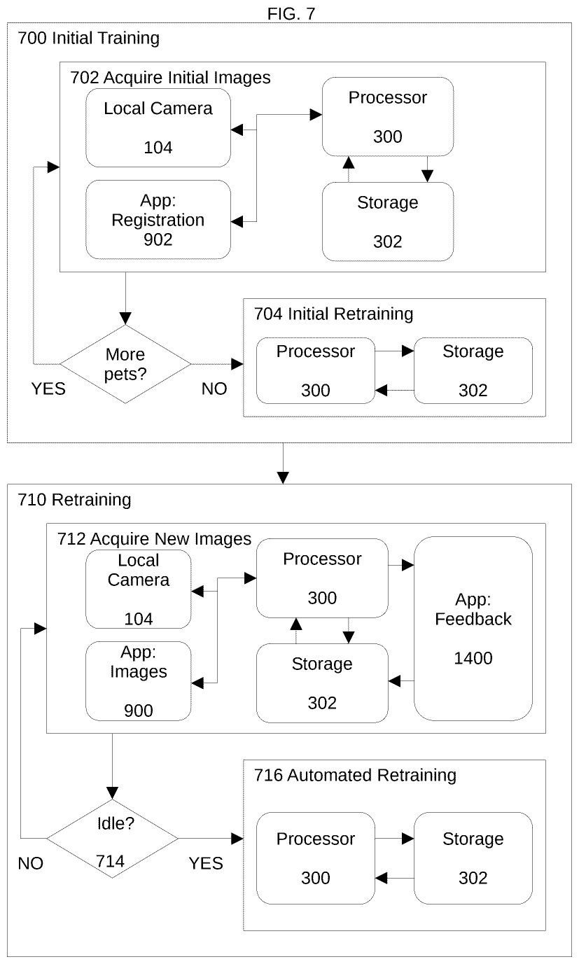

FIG. 7 is a flowchart depicting the machine learning model's training and retraining process. The invention allows for a continuously improving recognition model. The initial path is a user-initiated training process (700). Via the companion application (900) or by using the local camera (104) visible on the interior side of the door assembly (FIG. 2B), the user provides reference photos (Step 702) of a specific animal. The processor (300) then retrains the computer vision model (Step 704) using this new data to recognize the individual identity of that pet and saves the new model to a non-transitory computer-readable medium (302).

The second path is an automated retraining process (710). During normal operation, the system stores new images (Step 712) of recognized pets as they use the door. The user may also both upload additional images and provide corrective feedback through the user feedback screen (FIG. 9E). The processor then monitors for a low-activity period (Step 714), such as late at night when all schedules have expired. During this idle time, once a day, the system initiates an automatic retraining session (Step 716) using the newly collected images and the corrective feedback data to refine the model's accuracy. This ensures the system adapts as a pet grows or its appearance changes over time.

What has been described and illustrated herein is a preferred embodiment of the invention along with some of its variations. The terms, descriptions, and figures used herein are set forth by way of illustration only and are not meant as limitations. Those skilled in the art will recognize that many variations are possible within the spirit and scope of the invention, which is intended to be defined by the following claims (and their equivalents) in which all terms are meant in their broadest reasonable sense unless otherwise indicated. Any headings utilized within the description are for convenience only and have no legal or limiting effect.

1. A system for controlling animal access, comprising: a door assembly having a frame and a movable panel disposed within said frame; an electronically-controlled locking mechanism operatively coupled to said movable panel; a camera network comprising at least one local camera positioned to capture image data from a local area proximate to the door assembly, and at least one external camera positioned to capture image data from an external environment beyond said local area; a processor communicatively coupled to said camera network and said locking mechanism; and a non-transitory computer-readable medium storing instructions that, when executed by said processor, cause the system to: receive first image data from said one or more local cameras and second image data from said one or more external cameras; analyze the first and second image data using a computer vision model to generate a first set of classifications corresponding to the local area and a second set of classifications corresponding to the external environment; apply a set of predefined rules that synthesizes said first and second classification sets to generate a situational context; and selectively actuate said locking mechanism based on said situational context.

2. The system of claim 1, wherein the instructions, when executed by said processor, further cause the system to maintain said locking mechanism in a locked state to prevent a recognized pet from exiting if the second classification set includes a predefined threat in the external environment.

3. The system of claim 1, wherein the instructions, when executed by said processor, further cause the system to: identify, based on the second classification set, a predefined threat to a recognized pet also located in the external environment; generate a recall signal to prompt the recognized pet to return to the door assembly; actuate said locking mechanism to an unlocked state to permit ingress for the recognized pet; and actuate said locking mechanism after ingress by the recognized pet to prevent ingress by the predefined threat.

4. The system of claim 1, wherein the predefined rules dictate that the classification of a detected animal as a “predefined threat” is dependent on the individual identity of a recognized pet present in the situational context.

5. The system of claim 1, wherein the predefined rules dictate that said locking mechanism be maintained in a locked state if the first classification set includes a pest species in the local area, even if a recognized pet is also identified.

6. The system of claim 1, wherein the instructions, when executed by said processor, further cause the system to maintain said locking mechanism in a locked state if either said first or second classification set includes an unrecognized human, overriding any other rule that would otherwise unlock the mechanism.

7. The system of claim 1, wherein the instructions, when executed by said processor, further cause the system to: receive training data from a user, said training data corresponding both to a specific animal and the accuracy of specific classifications; and retrain said computer vision model using said training data to recognize an individual identity of said specific animal.

8. The system of claim 7, wherein the instructions, when executed by said processor, further cause the system to: store new images of said specific animal captured by the camera network during operation; and automatically schedule a retraining session to further update the computer vision model using the newly acquired images during a time of predetermined low activity.

9. The system of claim 1, further comprising an infrared light emitter positioned to illuminate an area for one or more of said local cameras or said external cameras.

10. The system of claim 1, further comprising an audio speaker, wherein the instructions, when executed by said processor, further cause the system to play a user-configurable audible tone via said audio speaker to indicate a status of the system.

11. The system of claim 10, wherein the audible tone is a recall signal to prompt a recognized pet to return to the door assembly.

12. The system of claim 1, wherein said camera network is a wireless mesh network.

13. A method for controlling animal access through an automated door, the method comprising: monitoring a local area proximate to the automated door with one or more local cameras; monitoring an external environment beyond the local area with one or more external cameras; receiving, at a central processor, first image data from the local camera and second image data from the external camera; analyzing, via said processor, the first and second image data using a computer vision model to generate a first classification set for the local area and a second classification set for the external environment; synthesizing, via said processor, the first and second classification sets to determine a situational context according to a set of predefined rules; and selectively actuating a locking mechanism of the automated door based on the determined situational context.

14. The method of claim 13, wherein determining the situational context comprises identifying a recognized pet in the local area requesting egress and a predefined threat in the external environment, and wherein actuating the locking mechanism comprises maintaining a locked state to prevent the pet from exiting.

15. The method of claim 13, wherein determining the situational context comprises identifying a recognized pet and a predefined threat concurrently in the external environment, and wherein the method further comprises the steps of: generating a recall signal to prompt the pet to return; unlocking the locking mechanism to permit the pet's ingress; and locking the locking mechanism after the pet's ingress to prevent the threat's ingress.

16. The method of claim 13, further comprising the steps of: receiving training data corresponding to a specific animal from a user; receiving training data corresponding to the accuracy of specific classifications from a user; and retraining said computer vision model using said training data to recognize an individual identity of said specific animal.
